(19) United States
(12) Patent Application Publication
(10) Pub. No.: US 2023/0207777 A1
(43) Pub. Date: Jun. 29, 2023

(54) NEGATIVE ELECTRODE LAYER, METHOD FOR MANUFACTURING NEGATIVE ELECTRODE LAYER, AND ALL-SOLID-STATE BATTERY

(71) Applicants: TOYOTA JIDOSHA KABUSHIKI KAISHA, Toyota-shi (JP); PANASONIC HOLDINGS CORPORATION, Osaka (JP)

(72) Inventors: Akio MITSUI, Anjo-shi (JP); Aiko NAGANO, Nisshin-shi (JP); Yasunari SUGITA, Osaka-shi (JP); Takaaki TAMURA, Mishima-gun (JP); Yasutaka TSUTSUI, Osaka-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 17/963,240

(22) Filed: Oct. 11, 2022

(30) Foreign Application Priority Data
Dec. 27, 2021 (JP) 2021-212462

(51) Int. Cl. H01M 4/131; H01M 10/0585; H01M 4/485; H01M 4/62; H01M 4/1391; H01M 10/0562

(52) U.S. Cl. CPC H01M 4/131; H01M 10/0585; H01M 4/485; H01M 4/622; H01M 4/1391; H01M 10/0562; H01M 2004/027

(57) ABSTRACT

A negative electrode layer that is used for an all-solid-state battery includes: lithium titanate; a sulfide solid electrolyte; and a rubber binder. The ratio of the amount A of the rubber binder adsorbed on the lithium titanate to the total content B of the rubber binder in the negative electrode layer is 1.35% or less.

### CROSS-REFERENCE TO RELATED APPLICATION

This application claims priority to Japanese Patent Application No. 2021-212462 filed on Dec. 27, 2021, incorporated herein by reference in its entirety.

### BACKGROUND

### 1. Technical Field

The present disclosure relates to negative electrode layers, methods for manufacturing a negative electrode layer, and all-solid-state batteries.

### 2. Description of Related Art

All-solid-state batteries are batteries having a solid electrolyte layer between a positive electrode layer and a negative electrode layer, and are advantageous in that it is easier to simplify a safety device as compared to liquid batteries having a liquid electrolyte containing a flammable organic solvent.

Titanium oxide is known as a negative electrode active material used in all-solid-state batteries. The volume change of titanium oxide during charging and discharging is small. For example, Japanese Unexamined Patent Application Publication No. 2021-128885 (JP 2021-128885 A) discloses a negative electrode for an all-solid-state battery including a negative electrode active material layer. This negative electrode active material layer includes a first particle group of titanium oxide and a second particle group of a sulfide solid electrolyte. In a cross section of the negative electrode active material layer, the length of the contact interface between the first particle group and the second particle group is 3.77 mm or more.

### SUMMARY

Negative electrode layers with low resistance are desired from the standpoint of implementing all-solid-state batteries with high input and output performance. The present disclosure provides a negative electrode layer with low resistance.

One aspect of the present disclosure is a negative electrode layer that is used in an all-solid-state battery. The negative electrode layer includes lithium titanate, a sulfide solid electrolyte, and a rubber binder. A ratio (A/B) of an amount A of the rubber binder adsorbed on the lithium titanate to a total content B of the rubber binder in the negative electrode layer is 1.35% or less.

According to the present disclosure, the ratio of the amount of the rubber binder adsorbed on the lithium titanate to the total content of the rubber binder in the negative electrode layer is equal to or less than a predetermined value. Therefore, the negative electrode layer has low resistance.

In the above disclosure, the rubber binder may contain styrene-butadiene rubber.

In the above disclosure, the lithium titanate of the negative electrode layer may have a composition represented by Li₄Ti₅O₁₂.

In the above disclosure, a proportion of the rubber binder in the negative electrode layer may be 1% by volume or more and 20% by volume or less. A proportion of the lithium titanate in the negative electrode layer may be 20% by volume or more and 80% by volume or less. A proportion of the sulfide solid electrolyte in the negative electrode layer may be 15% by volume or more and 75% by volume or less.

One aspect of the present disclosure is a method for manufacturing a negative electrode layer that is used for an all-solid-state battery. The method includes: preparing a dispersion in which a sulfide solid electrolyte and a first component are dispersed in a dispersion medium; adding a second component to the dispersion and dispersing the second component in the dispersion to obtain a negative electrode paste; and applying and drying the negative electrode paste to form the negative electrode layer. One of the first component and the second component is lithium titanate, and the other is a rubber binder.

According to the present disclosure, the dispersion in which at least the sulfide solid electrolyte is dispersed in the dispersion medium is prepared. The rubber binder and the lithium titanate are added separately when preparing the dispersion and when subsequently obtaining the negative electrode paste from the dispersion. This allows the rubber binder to be preferentially adsorbed on the sulfide solid electrolyte. Therefore, a negative electrode layer with low resistance can be manufactured.

In the above disclosure, the first component may be the lithium titanate, and the second component may be the rubber binder.

In the above disclosure, preparing the dispersion may include: adding the first component to the dispersion medium and performing a first dispersion process to obtain a precursor dispersion; and adding the sulfide solid electrolyte to the precursor dispersion and performing a second dispersion process to obtain the dispersion.

One aspect of the present disclosure is an all-solid-state battery including: a positive electrode layer; the above negative electrode layer; and a solid electrolyte layer located between the positive electrode layer and the negative electrode layer.

According to the present disclosure, an all-solid-state battery with low resistance is obtained by using the above negative electrode layer.

The present disclosure can provide a negative electrode layer with low resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing an example of a method for manufacturing a negative electrode layer in the present disclosure;

FIG. 2 is a schematic sectional view showing an example of an all-solid-state battery in the present disclosure;

FIG. 3 is a flowchart showing an example of a method for manufacturing a negative electrode layer of a comparative example;

FIG. 4A shows a scanning electron microscope (SEM) image of a cross section of a negative electrode layer in a battery for evaluation obtained in an example;

FIG. 4B shows a mapping image of carbon (C image) in the cross section of the negative electrode layer in the battery for evaluation obtained in the example;

FIG. 4C shows a mapping image of sulfur (S image) in the cross section of the negative electrode layer in the battery for evaluation obtained in the example;

FIG. 4D shows a mapping image of sulfur and osmium (S, Os image) in the cross section of the negative electrode layer in the battery for evaluation obtained in the example;

FIG. 5A shows a mapping image of sulfur and osmium (S, Os image) in the cross section of the negative electrode layer in the battery for evaluation obtained in the example;

FIG. 5B shows an image obtained by separating the mapping image of FIG. 5A by coloring both regions where Os elements exist and regions where S elements exist red and coloring the remaining regions black;

FIG. 5C shows an image obtained by extracting Os elements adsorbed on lithium titanate from the image of FIG. 5B;

FIG. 6A shows an SEM image of a cross section of the negative electrode layer in the battery for evaluation obtained in the example;

FIG. 6B shows a mapping image of sulfur and osmium (S, Os image) in the cross section of the negative electrode layer in the battery for evaluation obtained in the example;

FIG. 6C shows an extracted image of Os elements adsorbed on lithium titanate in the cross section of the negative electrode layer in the battery for evaluation obtained in the example;

FIG. 6D shows an SEM image of a cross section of a negative electrode layer in a battery for evaluation obtained in a comparative example;

FIG. 6E shows a mapping image of sulfur and osmium (S, Os image) in the cross section of the negative electrode layer in the battery for evaluation obtained in the comparative example; and

FIG. 6F shows an extracted image of Os elements adsorbed on lithium titanate in the cross section of the negative electrode layer in the battery for evaluation obtained in the comparative example.

### DETAILED DESCRIPTION OF EMBODIMENTS

Hereinafter, a negative electrode layer, a method for manufacturing a negative electrode layer, and an all-solid-state battery in the present disclosure will be described in detail.

A. Negative Electrode Layer

A negative electrode layer in the present disclosure includes lithium titanate, a sulfide solid electrolyte, and a rubber binder. The ratio (A/B) of the amount A of the rubber binder adsorbed on the lithium titanate to the total content B of the rubber binder in the negative electrode layer is 1.35% or less. The negative electrode layer in the present disclosure is used for all-solid-state batteries.

According to the present disclosure, the ratio of the amount of the rubber binder adsorbed on the lithium titanate to the total content of the rubber binder in the negative electrode layer is equal to or less than a predetermined value. Therefore, the negative electrode layer has low resistance. As described above, in the case of a negative electrode layer including lithium titanate and a rubber binder, the lithium titanate and the rubber binder have a high affinity for each other. Therefore, the rubber binder is easily adsorbed on the lithium titanate. When the surface of the lithium titanate is covered with the rubber binder, the reaction area of the lithium titanate as an active material is reduced. Therefore, the negative electrode layer may have high resistance.

For example, silicon particles are known as a negative electrode active material for batteries. The affinity between the silicon particles and the rubber binder is lower than that between the lithium titanate and the rubber binder. Therefore, in the case of a negative electrode layer using silicon particles as a negative electrode active material, it is unlikely that the negative electrode layer has high resistance due to the binder being easily adsorbed on the negative electrode active material.

A fluoride binder such as polyvinylidene fluoride (PVDF) has low dispersibility in a dispersion medium that is used together with a sulfide solid electrolyte. Therefore, a fluoride binder tends to aggregate in a negative electrode layer. In the case of a negative electrode layer using such a fluoride binder as a binder, it is unlikely that the negative electrode layer has high resistance due to the binder being easily adsorbed on a negative electrode active material.

As described above, the problem of a negative electrode layer having high resistance is particularly apparent when the negative electrode layer uses lithium titanate as a negative electrode active material and a rubber binder as a binder. In this regard, in the negative electrode layer of the present disclosure, the ratio of the amount of the rubber binder adsorbed on the lithium titanate to the total content of the rubber binder in the negative electrode layer is equal to or less than the predetermined value. Therefore, a decrease in reaction area of the lithium titanate can be reduced, and the resistance of the negative electrode layer can be reduced.

1. Rubber Binder

The negative electrode layer in the present disclosure includes a rubber binder. In the present disclosure, the ratio (A/B) of the amount A of the rubber binder adsorbed on the lithium titanate to the total content B of the rubber binder in the negative electrode layer is usually 1.35% or less, and may be 1.0% or less. When the ratio (A/B) is high, the reaction area of the lithium titanate is reduced, and the resistance is increased. The ratio (A/B) is, for example, 0% or more, and may be 0.5% or more. The ratio (A/B) is measured by the following procedure.

Staining of Electrode

In an inert atmosphere such as a glovebox, at least a part of an outer body of an all-solid state battery is removed to expose a power generating element. The all-solid-state battery with the exposed power generating element is set in an atmosphere non-exposure chamber and transferred into a vacuum electron staining apparatus. The vacuum electron staining apparatus is, for example, VSC4TWDH (made by Filgen, Inc.). After creating a vacuum atmosphere in the vacuum electron staining apparatus, the chamber is opened, and osmium tetroxide (OsO₄) gas is introduced into the chamber. The staining time, the gas concentration, etc. are adjusted and osmium (Os) staining is performed. Osmium tetroxide (OsO₄) reacts with double bonds of the rubber binder and is adsorbed on the rubber binder.

Production of Test Piece

The osmium-stained power generating element is cut to a suitable size in an inert atmosphere. A test piece of the power generating element is thus produced. Cross-section processing is performed on a cut surface of the test piece by an ion milling system using an atmosphere non-exposure milling holder etc. For example, an ion milling system “IM4000PLUS” made by Hitachi High-Tech Corporation (or an equivalent product) may be used. The cross-section processing is performed in a vacuum atmosphere or an inert atmosphere. The test piece may be cooled during the cross-section processing.

Acquisition of Images

After the cross-section processing, the test piece is placed in a field emission scanning electron microscope (FE-SEM). For example, FE-SEM “Regulus 8230” made by Hitachi High-Tech Corporation (or an equivalent product) may be used. The vacuum atmosphere is maintained from when the cross-section processing is performed until the test piece is placed in the SEM so that the test piece will not be exposed to the atmosphere.

A cross section of a negative electrode layer of the test piece is observed by the FE-SEM. It is preferable to select a position where no electrically conductive material is observed as an observation position of the cross section of the negative electrode layer. This is because the total content B of the rubber binder can be accurately calculated. Secondary and backscattered electron images are observed at the observation position using SEM. The observation magnification is, for example, 5000 times. At the same observation position, a mapping image of carbon (C), a mapping image of sulfur (S), and a mapping image of sulfur (S) and osmium (Os) are acquired by energy dispersive X-ray spectroscopy (EDX). The above observation is preferably made at a plurality of positions. In this case, for example, six observation positions are set at substantially equal intervals in a plane direction parallel to a negative electrode current collector, that is, in a direction perpendicular to the thickness direction of the negative electrode layer.

Image Analysis

The following amounts are measured using the images acquired as described above: (1) the total content B of the rubber binder, and (2) the amount A of the rubber binder adsorbed on the lithium titanate.

(1) Measurement of Total Content B of Rubber Binder

First, the mapping image of carbon is binarized, and the number of pixels P1 in the extracted image of C elements is counted. The mapping image of carbon is literally an image that maps the presence of carbon. Since the mapping image of carbon is a simple image for image processing, the number of pixels P1 can be accurately counted by a known binarization process. For example, a threshold value for the binarization may be set in consideration of at least one of the following volume ratios: the volume ratio of the lithium titanate, the volume ratio of the electrically conductive material, and the volume ratio of the rubber binder.

Next, the mapping image of sulfur is binarized, and the number of pixels P2 in the extracted image of S elements is counted. The mapping image of sulfur is literally an image that maps the presence of sulfur. Since the mapping image of sulfur is a simple image for image processing, the number of pixels P2 can be accurately counted by a known binarization process. For example, a threshold value for the binarization may be set in consideration of either or both of the volume ratio of the lithium titanate and the volume ratio of the sulfide solid electrolyte.

Next, the number of pixels P3 is calculated by subtracting P2 from P1. In the present disclosure, P3 is defined as the total content B of the rubber binder. In addition to the form of the sulfide solid electrolyte, the form of the lithium titanate is also observed in the mapping image of carbon. The form of the lithium titanate observed in the mapping image of carbon is due to the surface functional groups of the lithium titanate and the residue of a solvent. Both the surface functional groups and the residue of the solvent are present in small amounts. Therefore, P3 can be defined as the total content B of the rubber binder.

(2) Measurement of Amount a of Rubber Binder Adsorbed on Lithium Titanate

The mapping image of osmium (Os) and sulfur (S) is separated into a region where Os elements and S elements are present and the remaining region. Next, a large mass of area (S elements of the sulfide solid electrolyte and Os elements covering the S elements of the sulfide solid electrolyte) is removed. The remaining Os elements, that is, the Os elements adsorbed on the lithium titanate, are thus extracted. The number of pixels P4 in the extracted image of the Os elements is counted.

The ratio (A/B) is calculated by dividing the number of pixels P4 obtained in (2) by the number of pixels P3 obtained in (1) and expressing the quotient as a percentage ((P4/P3)×100 (%)). When the observation was made at a plurality of positions (e.g., six positions), “(P4/P3)×100 (%)” is obtained for each observation position, and the average value thereof is used as the ratio (A/B).

Rubber Binder

The rubber binder in the present disclosure can be any known rubber binder that is used as a binder for all-solid-state batteries. Examples of rubber contained in the rubber binder include butadiene rubber, hydrogenated butadiene rubber, styrene-butadiene rubber (SBR), hydrogenated styrene-butadiene rubber, nitrile butadiene rubber, hydrogenated nitrile butadiene rubber, and ethylene-propylene rubber. Among these, styrene-butadiene rubber (SBR) is preferable.

The proportion of the rubber binder in the negative electrode layer is, for example, 1% by volume or more and 20% by volume or less, and may be 5% by volume or more and 20% by volume or less.

2. Lithium Titanate

The negative electrode layer in the present disclosure contains lithium titanate. Lithium titanate functions as a negative electrode layer active material.

Lithium titanate (LTO) is a compound containing lithium (Li), titanium (Ti), and oxygen (O). A part of Ti in the lithium titanate may be substituted with other metal element (e.g., a transition metal element). A part of Li in the lithium titanate may be substituted with other metal element (e.g., an alkali metal element). The lithium titanate may have a crystalline phase with a spinel structure.

An example of the composition of the lithium titanate is LiₓTi_{y}O_{z} (3.5≤x≤4.5, 4.5≤y≤5.5, 11≤z≤13). In the above composition, x may be 3.7 or more and 4.3 or less, or 3.9 or more and 4.1 or less, y may be 4.7 or more and 5.3 or less, or 4.9 or more and 5.1 or less, and z may be 11.5 or more and 12.5 or less, or 11.7 or more and 12.3 or less. The lithium titanate preferably has a composition represented by Li₄Ti₅O₁₂.

The form of the lithium titanate is, for example, particles. The average particle size (D₅₀) of the lithium titanate is, for example, 10 nm or more and 50 μm or less, and may be 100 nm or more and 20 μm or less. The average particle size (D₅₀) refers to the particle size (median particle size) when the cumulative percentage reaches 50% in a cumulative particle size distribution, and is calculated from, for example, measurements using a laser diffraction particle size analyzer or a scanning electron microscope (SEM).

The specific surface area of the lithium titanate is, for example, 2 m²/g or more and 10 m²/g or less, and may be 3 m²/g or more and 8 m²/g or less, and 3.9 m²/g or more and 6.5 m²/g or less. The specific surface area is calculated from measurement by, for example, a gas adsorption method such as the Brunauer-Emmett-Teller (BET) method.

The lithium titanate preferably exhibits satisfactory electron conductivity by insertion of Li. The electron conductivity (25° C.) of the Li-inserted lithium titanate is, for example, 8.0×10⁻¹ S/cm or more.

The proportion of the lithium titanate in the negative electrode layer is, for example, 20% by volume or more and 80% by volume or less, and may be 30% by volume or more and 70% by volume or less, or 40% by volume or more and 65% by volume or less. When the proportion of the lithium titanate is low, the volumetric energy density may be reduced. On the other hand, when the proportion of the lithium titanate is high, ion conduction paths may not be sufficiently formed.

3. Sulfide Solid Electrolyte

The negative electrode layer in the present disclosure contains a sulfide solid electrolyte. The sulfide solid electrolyte forms ion conduction paths in the negative electrode layer. The sulfide solid electrolyte usually contains sulfur (S) as a main component of anionic elements. The sulfide solid electrolyte contains, for example, Li, A (A is at least one of the following elements: phosphorus (P), arsenic (As), antimony (Sb), silicon (Si), germanium (Ge), tin (Sn), boron (B), aluminum (Al), gallium (Ga), and indium (In)), and S. A preferably contains at least P, and the sulfide solid electrolyte may contain at least one of the following elements as a halogen: chlorine (Cl), bromine (Br), and iodine (I). The sulfide solid electrolyte may contain O.

The sulfide solid electrolyte may be a sulfide glass solid electrolyte, a sulfide glass ceramic solid electrolyte, or a crystalline sulfide solid electrolyte. When the sulfide solid electrolyte has a crystalline phase, examples of the crystalline phase include a thio-lithium super ionic conductor (thio-LISICON) phase, an LGPS phase, and an argyrodite phase.

The composition of the sulfide solid electrolyte is, for example, but not particularly limited to, xLi₂S·(100−x)P₂S₅ (70≤x≤80) or yLiI·zLiBr·(100−y−z)(xLi₂S·(1−x)P₂S₅) (0.7≤x≤0.8, 0≤y≤30, 0≤z≤30).

The sulfide solid electrolyte may have a composition represented by the general formula: Li₄₋ₓGe₁₋ₓPₓS₄ (0<x<1). In this general formula, at least a part of Ge may be substituted with at least one of the following elements: antimony (Sb), silicon (Si), tin (Sn), boron (B), aluminum (Al), gallium (Ga), indium (In), titanium (Ti), zirconium (Zr), vanadium (V), and niobium (Nb). In this general formula, at least a part of P may be substituted with at least one of the following elements: Sb, Si, Sn, B, Al, Ga, In, Ti, Zr, V, and Nb. In this general formula, a part of Li may be substituted with at least one of the following elements: sodium (Na), potassium (K), magnesium (Mg), calcium (Ca), and zinc (Zn). In this general formula, a part of S may be substituted with a halogen (at least one of the following elements: fluorine (F), chlorine (Cl), bromine (Br) and iodine (I)).

Other examples of the composition of the sulfide solid electrolyte include Li_{7-x-2y}PS_{6-x-y}X_{y}, Li_{8-x-2y}SiS_{6-x-y}X_{y}, Li_{8-x-2y}GeS_{6-x-y}X_{y}. In these compositions, X is at least one of the following elements: F, Cl, Br, and I, and x and y satisfy 0<x, 0<y.

The sulfide solid electrolyte preferably has high Li ion conductivity. The Li ion conductivity of the sulfide solid electrolyte at 25° C. is, for example, 1×10⁻⁴ S/cm or more, and preferably 1×10⁻³ S/cm or more. The sulfide solid electrolyte preferably has high insulating properties. The electron conductivity of the sulfide solid electrolyte at 25° C. is, for example, 10⁻⁶ S/cm or less, and may be 10⁻⁸ S/cm or less, or 10⁻¹⁰ S/cm or less. The form of the sulfide solid electrolyte is, for example, particles. The average particle size (D₅₀) of the sulfide solid electrolyte is, for example, 0.1 μm or more and 50 μm or less.

The proportion of the sulfide solid electrolyte in the negative electrode layer is, for example, 15% by volume or more and 75% by volume or less, and may be 15% by volume or more and 60% by volume or less. When the proportion of the sulfide solid electrolyte is low, ion conduction paths may not be sufficiently formed. On the other hand, when the proportion of the sulfide solid electrolyte is high, the volumetric energy density may be reduced.

4. Negative Electrode Layer

The negative electrode layer in the present disclosure may or may not contain an electrically conductive material. The “electrically conductive material” in the present disclosure refers to a material having an electron conductivity higher than the electron conductivity of the lithium titanate (to be exact, the electron conductivity of the Li-inserted lithium titanate). Examples of the electrically conductive material include a carbon material, metal particles, and a conductive polymer. Examples of the carbon material include particle carbon materials such as acetylene black (AB) and Ketjen black (KB), and fibrous carbon materials such as carbon fibers, carbon nanotubes (CNTs), and carbon nanofibers (CNFs). The proportion of the electrically conductive material in the negative electrode layer is, for example, 0.1% by volume or more and 10% by volume or less, and may be 0.3% by volume or more and 10% by volume or less. When the negative electrode layer does not contain an electrically conductive material, the material having the highest electron conductivity in the negative electrode layer is preferably the lithium titanate.

The thickness of the negative electrode layer is, for example, 0.1 μm or more and 1000 μm or less.

B. Method for Manufacturing Negative Electrode Layer

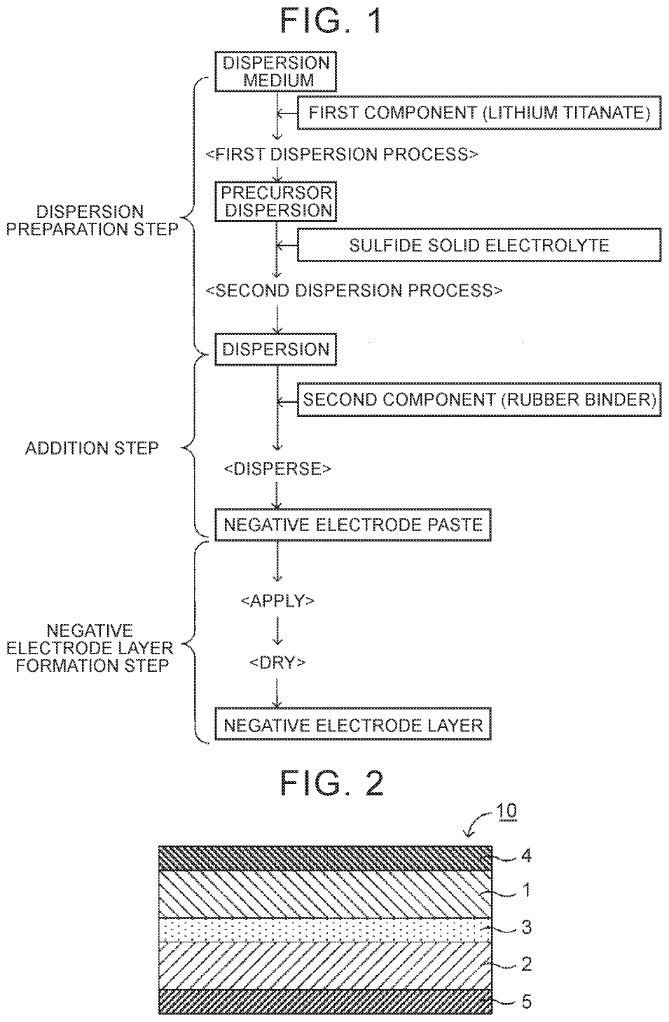

FIG. 1 is a flowchart showing an example of a method for manufacturing a negative electrode layer in the present disclosure. In the manufacturing method shown in FIG. 1, a dispersion in which a sulfide solid electrolyte and a first component are dispersed in a dispersion medium is first prepared (dispersion preparation step). Next, a second component is added to and dispersed in the dispersion to obtain a negative electrode paste (addition step). One of the first component and the second component is lithium titanate, and the other is a rubber binder. The negative electrode paste is then applied and dried to form a negative electrode layer (negative electrode layer formation step).

The affinity of the rubber binder for the sulfide solid electrolyte is slightly higher than, but is substantially the same as, the affinity of the rubber binder for the lithium titanate. Therefore, if the lithium titanate and the rubber binder come into contact with each other in the absence of the sulfide solid electrolyte in the process of producing the negative electrode paste, an increased amount of the rubber binder is adsorbed on the lithium titanate.

However, the method for manufacturing a negative electrode layer in the present disclosure includes the dispersion preparation step of preparing a dispersion in which at least a sulfide solid electrolyte is dispersed in a dispersion medium. A rubber binder and lithium titanate are separately added in the dispersion preparation step and in the subsequent addition step. Accordingly, the lithium titanate and the rubber binder can be avoided from coming into contact with each other in the absence of the sulfide solid electrolyte, and the rubber binder preferentially covers the sulfide solid electrolyte. Therefore, the amount of the rubber binder that covers the lithium titanate can be reduced.

In the present disclosure, it is preferable that the first component be the lithium titanate and the second component be the rubber binder. The first component may be the rubber binder and the second component may be the lithium titanate.

1. Dispersion Preparation Step

The dispersion preparation step is the step of preparing a dispersion in which a sulfide solid electrolyte and a first component are dispersed in a dispersion medium. The first component is lithium titanate or a rubber binder. The first component is preferably lithium titanate. Since the sulfide solid electrolyte, the lithium titanate, and the rubber binder are similar to those described above in “A. Negative electrode layer,” description thereof will be omitted.

The dispersion medium in the present disclosure gives fluidity to the dispersion. The dispersion medium may dissolve a part of the sulfide solid electrolyte and a part of the first component. Examples of the dispersion medium include: esters such as butyl butyrate, dibutyl ether, and ethyl acetate; ketones such as diisobutyl ketone (DIBK), methyl ketone, and methyl propyl ketone; aromatic hydrocarbons such as xylene, benzene, and toluene; alkanes such as heptane, dimethylbutane, and methylhexane; and amines such as tributylamine and allylamine. The solids concentration of the dispersion is, for example, 30% by weight or more and 80% by weight or less, and may be 50% by weight or more and 70% by weight or less.

The method for producing a dispersion in the present disclosure is not particularly limited. An example of a method for producing a dispersion includes the step of obtaining a precursor dispersion and the step of obtaining a dispersion. In the step of obtaining a precursor dispersion, for example, as shown in FIG. 1, the first component (lithium titanate in FIG. 1) is added to the dispersion medium and a first dispersion process is performed to obtain a precursor dispersion. In the step of obtaining a dispersion, the sulfide solid electrolyte is added to the precursor dispersion and a second dispersion process is performed to obtain a dispersion.

Although not shown in the figure, another example of the method for producing a dispersion may include: the step of obtaining a precursor dispersion by adding the sulfide solid electrolyte to the dispersion medium and performing the first dispersion process; and the step of obtaining a dispersion by adding the first component to the precursor dispersion and performing the second dispersion process. Still another example of the method for producing a dispersion may include the step of obtaining a dispersion by adding both the first component and the sulfide solid electrolyte to the dispersion medium and performing a dispersion process.

A known appropriate method can be used for the dispersion process. An example of the dispersion process is a method using an ultrasonic homogenizer. It is preferable to adjust a condition for the dispersion process as appropriate so that a desired dispersion can be obtained.

In the present disclosure, an electrically conductive material may be added in the dispersion preparation step. The electrically conductive material may be added simultaneously with the first component, may be added simultaneously with the sulfide solid electrolyte, or may be added simultaneously with the first component and the sulfide solid electrolyte. The electrically conductive material may be added separately from the first component and the sulfide solid electrolyte.

2. Addition Step

The addition step is the step of adding a second component to the dispersion prepared in “1. Dispersion Preparation Step” and dispersing the second component in the dispersion to produce a negative electrode paste. The second component is lithium titanate or a rubber binder. The second component is preferably a rubber binder.

In the present disclosure, since a method similar to that described above is used for the dispersion process, description thereof will be omitted.

In the present disclosure, an electrically conductive material may be added in the addition step. In this case, the electrically conductive material and the second component may be added at the same time, the electrically conductive material may be added first, followed by the second component, or the second component may be added first, followed by the electrically conductive material.

3. Negative Electrode Layer Formation Step

The negative electrode layer formation step is the step of forming a negative electrode layer by applying and drying the negative electrode paste produced in “2. Addition Step.” The negative electrode paste is preferably applied to a current collector. The method for applying the negative electrode paste is not particularly limited, and a known appropriate application method can be used. The negative electrode layer produced through each of the above steps is similar to that described above in “A. Negative Electrode Layer,” description thereof will be omitted.

C. All-Solid-State Battery

FIG. 2 is a schematic sectional view illustrating an example of an all-solid-state battery in the present disclosure. An all-solid-state battery 10 shown in FIG. 2 includes a positive electrode layer 1, a negative electrode layer 2, a solid electrolyte layer 3 located between the positive electrode layer 1 and the negative electrode layer 2, a positive electrode current collector 4 that collects current from the positive electrode layer 1, and a negative electrode current collector 5 that collects current from the negative electrode layer 2. In the present disclosure, the negative electrode layer 2 is the negative electrode layer described above in “A. Negative Electrode Layer.”

According to the present disclosure, an all-solid-state battery with low resistance is obtained by using the above negative electrode layer.

1. Negative Electrode Layer

Since the negative electrode layer in the present disclosure is similar to that described above in “A. Negative Electrode Layer,” description thereof will be omitted.

2. Positive Electrode Layer

The positive electrode layer in the present disclosure contains at least a positive electrode active material. The positive electrode layer in the present disclosure may further contain at least one of the following materials as necessary: a solid electrolyte, an electrically conductive material, and a binder. An example of the positive electrode active material is an oxide active material. Examples of the oxide active material include layered rock-salt active materials such as LiCoO₂, LiMnO₂, LiNiO₂, LiVO₂, and LiNi_{1/3}Co_{1/3}Mn_{1/3}O₂, spinel active materials such as LiMn₂O₄, Li₄Ti₅O₁₂, and Li(Ni_{0.5}Mn_{1.5})O₄, and olivine active materials such as LiFePO₄, LiMnPO₄, LiNiPO₄, and LiCoPO₄. The surface of the positive electrode active material is preferably coated with an ion conductive oxide. This is because the possibility of formation of a high resistance layer due to the reaction between the positive electrode active material and the solid electrolyte (particularly the sulfide solid electrolyte) can be reduced. An example of the ion conductive oxide is LiNbO₃. The thickness of the ion conductive oxide is, for example, 1 nm or more and 30 nm or less.

The proportion of the positive electrode active material in the positive electrode layer is, for example, 20% by volume or more, and may be 30% by volume or more, or 40% by volume or more. When the proportion of the positive electrode active material is low, the volumetric energy density may be reduced. The proportion of the positive electrode active material may be, for example, 80% by volume or less, and may be 70% by volume or less, or 60% by volume or less. When the proportion of the positive electrode active material is high, ion conduction paths and electron conduction paths may not be sufficiently formed.

The solid electrolyte is, for example, but not particularly limited to, a sulfide solid electrolyte. Details of the sulfide solid electrolyte are similar to those described above in “A. Negative Electrode Layer.” The electrically conductive material and the binder are similar to those described in “A. Negative Electrode Layer.” The thickness of the positive electrode layer is, for example, 0.1 μm or more and 1000 μm or less.

3. Solid Electrolyte Layer

The solid electrolyte layer in the present disclosure is located between the positive electrode layer and the negative electrode layer. The solid electrolyte layer contains at least a solid electrolyte and may further contain a binder. Since the solid electrolyte and the binder are similar to those described above in “2. Positive Electrode Layer,” description thereof will be omitted. The thickness of the solid electrolyte layer is, for example, 0.1 μm or more and 1000 μm or less.

4. All-Solid-State Battery

In the present disclosure, the “all-solid-state battery” refers to a battery including a solid electrolyte layer (layer containing at least a solid electrolyte). The all-solid-state battery in the present disclosure includes a power generating element including a positive electrode layer, a solid electrolyte layer, and a negative electrode layer. The power generating element usually includes a positive electrode current collector and a negative electrode current collector. The positive electrode current collector is located on, for example, the opposite surface of the positive electrode layer from the solid electrolyte layer. Examples of the material of the positive electrode current collector include metals such as aluminum, SUS, and nickel. Examples of the form of the positive electrode current collector include foil and mesh. The negative electrode current collector is located on, for example, the opposite surface of the negative electrode layer from the solid electrolyte layer. Examples of the material of the negative electrode current collector include metals such as copper, SUS, and nickel. Examples of the form of the negative electrode current collector include foil and mesh.

The all-solid-state battery in the present disclosure may include an outer body housing the power generating element. Examples of the outer body include a laminated outer body and a case-type outer body. The all-solid-state battery in the present disclosure may include a restraining jig that applies a restraining pressure in the thickness direction to the power generating element. The restraining jig may be a known jig. The restraining pressure is, for example, 0.1 MPa or more and 50 MPa or less, and may be 1 MPa or more and 20 MPa or less. When the restraining pressure is low, satisfactory ion conduction paths and satisfactory electron conduction paths may not be formed. On the other hand, when the restraining pressure is high, a larger restraining jig is used, and the volumetric energy density of the all-solid-state battery may be reduced.

The type of the all-solid-state battery in the present disclosure is not particularly limited, but is typically a lithium-ion secondary battery. Applications of the all-solid-state battery are, for example, but not particularly limited to, power supplies for vehicles such as hybrid electric vehicles (HEVs), plug-in hybrid electric vehicles (PHEVs), battery electric vehicles (BEVs), gasoline vehicles, and diesel vehicles. The all-solid state battery in the present disclosure is preferably used particularly as traction power supplies for hybrid electric vehicles, plug-in hybrid electric vehicles, or battery electric vehicles. The all-solid-state battery in the present disclosure may be used as power sources for moving bodies other than vehicles (e.g., trains, ships, and aircrafts), or may be used as power sources for electrical products such as information processing devices.

The present disclosure is not limited to the above embodiment. The above embodiment is illustrative, and anything having substantially the same configuration as, and having similar functions and effects to, the technical idea described in the claims of the present disclosure is included in the technical scope of the present disclosure.

### EXAMPLE

Production of Negative Electrode Paste

Li₄Ti₅O₁₂ particles (LTO, density: 3.5 g/cc) as a negative electrode active material, an electrically conductive material (vapor-grown carbon fibers (VGCFs), density: 2 g/cc), a binder (SBR, density: 0.9 g/cc), a dispersion medium (butyl butyrate), and a sulfide solid electrolyte (LiI—LiBr—Li₂S—P₂S₅ glass ceramic, density: 2 g/cc) were weighed.

A negative electrode paste was produced according to the flowchart shown in FIG. 1. First, the LTO particles were added to the dispersion medium, and the first dispersion process was performed using an ultrasonic homogenizer (UH-50 made by SMT Co., Ltd.) to obtain a precursor dispersion. Next, the sulfide solid electrolyte was added to the obtained precursor dispersion, and a second dispersion process was performed using the ultrasonic homogenizer (UH-50 made by SMT Co., Ltd.) to obtain a dispersion. Next, the binder was added to the dispersion and dispersed therein using the ultrasonic homogenizer (UH-50 made by SMT Co., Ltd.) to obtain a negative electrode paste.

Production of Positive Electrode Paste

LiNi_{1/3}Co_{1/3}Mn_{1/3}O₂ surface-treated with LiNbO₃ was used as a positive electrode active material. This positive electrode active material, an electrically conductive material (VGCF), a sulfide solid electrolyte, a binder (SBR), and a dispersion medium (butyl butyrate) were weighed and mixed using the ultrasonic homogenizer (UH-50 made by SMT Co., Ltd.). A positive electrode paste was thus obtained.

Production of Paste for Solid Electrolyte (SE) Layer

A dispersion medium (heptane), a binder (heptane solution containing 5% by mass of a butadiene rubber binder), and a sulfide solid electrolyte (LiI—LiBr—Li₂S—P₂S₅ glass ceramic, average particle size D₅₀: 2.5 μm) were added to a polypropylene container and mixed for 30 seconds using the ultrasonic homogenizer (UH-50 made by SMT Co., Ltd.). The container was then shaken with a shaker for 3 minutes. A paste for a solid electrolyte layer (paste for SE layer) was thus obtained.

Production of All-Solid-State Battery

First, the positive electrode paste was applied to a positive electrode current collector (aluminum foil) by a blade method using an applicator. The applied positive electrode paste was then dried on a hot plate at 100° C. for 30 minutes. A positive electrode having a positive electrode current collector and a positive electrode layer was thus obtained. Next, the negative electrode paste was applied to a negative electrode current collector (copper foil). The applied negative electrode paste was then dried on a hot plate at 100° C. for 30 minutes. A negative electrode having a negative electrode current collector and a negative electrode layer was thus obtained. The basis weight of the negative electrode layer was adjusted so that the specific charging capacity of the negative electrode was 1.15 times the specific charging capacity of the positive electrode when the specific charting capacity of the positive electrode was 185 mAh/g.

Thereafter, the positive electrode was pressed. The paste for SE layer was applied to the surface of the positive electrode layer after the pressing by using a die coater. The applied paste for SE layer was dried on a hot plate at 100° C. for 30 minutes. Roll pressing was then performed at a line pressure of 2 tons/cm. A positive electrode-side laminate including a positive electrode current collector, a positive electrode layer, and a solid electrolyte layer was thus obtained. Subsequently, the negative electrode was pressed. The paste for SE layer was applied to the surface of the negative electrode layer after the pressing by using a die coater. The applied paste for SE layer was dried on a hot plate at 100° C. for 30 minutes. Roll pressing was then performed at a line pressure of 2 tons/cm. A negative electrode-side laminate including a negative electrode current collector, a negative electrode layer, and a solid electrolyte layer was thus obtained.

The positive electrode-side laminate and the negative electrode-side laminate were blanked, and the blanks were arranged such that the solid electrolyte layers faced each other, and an unpressed solid electrolyte layer was placed between the blanks. The stack thus obtained was then roll-pressed at 130° C. at a liner pressure of 2 tons/cm to obtain a power generating element including a positive electrode, a solid electrolyte layer, and a negative electrode in this order. The obtained power generating element was laminated and sealed and was restrained at 5 MPa to obtain an all-solid-state battery for evaluation.

Calculation of Ratio (AB) (%)

The power generating element of the all-solid-state battery produced in the example was exposed. The all-solid-state battery in this state was set in an atmosphere non-exposure chamber and transferred into a vacuum electron staining apparatus (VSC4TWDH (made by Filgen, Inc.)). After creating a vacuum atmosphere in the vacuum electron staining apparatus, osmium tetroxide (OsO₄) gas was introduced into the chamber. The chamber was then opened. The staining time, the gas concentration, etc. were adjusted, and osmium (Os) staining was performed.

Production of Test Piece

The osmium-stained power generating element was cut to a suitable size in an inert atmosphere to produce a test piece. Cross-section processing was performed on a cut surface of the test piece in a vacuum atmosphere by an ion milling system (IM4000PLUS made by Hitachi High-Tech Corporation).

Acquisition of Images

After the cross-section processing, the test piece was placed in a field emission scanning electron microscope (FE-SEM “Regulus 8230” made by Hitachi High-Tech Corporation). The vacuum atmosphere was maintained from when the cross-section processing was performed until the test piece was placed in the SEM so that the test piece would not be exposed to the atmosphere.

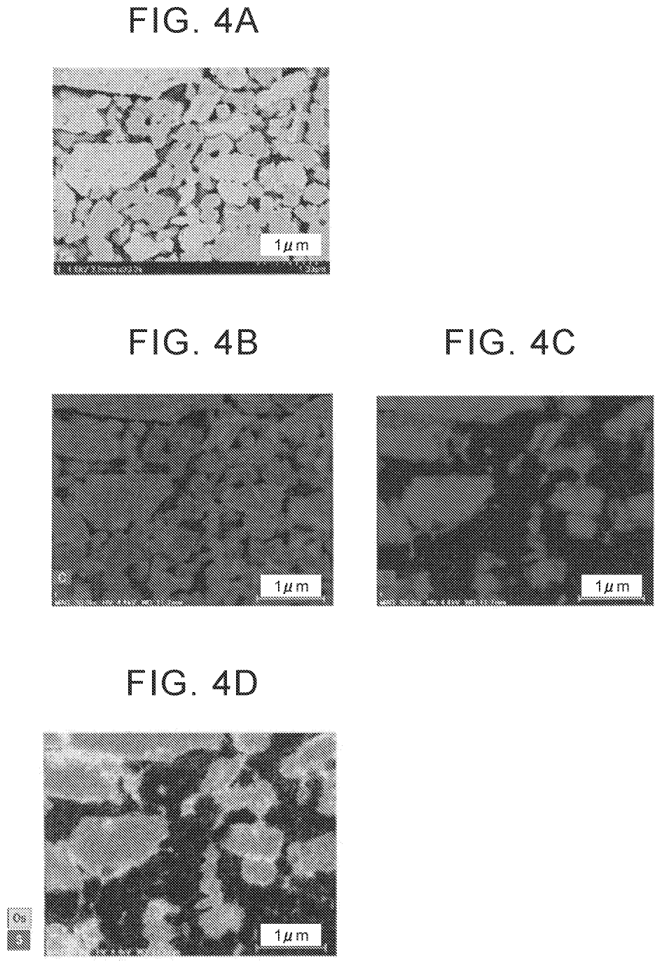

The cross section of the negative electrode layer of the test piece was observed by FE-SEM. Six observation positions were set at substantially equal intervals in a plane direction parallel to the negative electrode current collector, that is, in a direction perpendicular to the thickness direction of the negative electrode layer. The positions where no electrically conductive material would be displayed were selected as the observation positions. Secondary and backscattered electron images were observed at each observation position using SEM. The observation magnification was 5000 times. At the same observation positions, elemental mapping images of carbon (C), sulfur (S), and sulfur (S) and osmium (Os) were acquired by EDX. FIG. 4A shows an SEM image of the cross section of the negative electrode layer, FIG. 4B shows a mapping image of carbon (C image) in the cross section of the negative electrode layer, FIG. 4C shows a mapping image of sulfur (S image) in the cross section of the negative electrode layer, and FIG. 4D shows a mapping image of sulfur and osmium (S, Os image) in the cross section of the negative electrode layer.

Image Analysis

The following amounts are measured using the images acquired as described above: (1) the total content B of the rubber binder, and (2) the amount A of the rubber binder adsorbed on the lithium titanate.

(1) Measurement of total content B of rubber binder

First, the mapping image of carbon (C image) was binarized. The number of pixels P1 in the extracted image of C elements was counted to be 193,890 pixels.

Next, the mapping image of sulfur (S image) was binarized. The number of pixels P2 in the extracted image of S elements was counted to be 100,660 pixels.

Thereafter, the number of pixels P3 was obtained by subtracting P2 from P1, and P3 was 93,230 pixels.

(2) Measurement of Amount A of Rubber Binder Adsorbed on Lithium Titanate

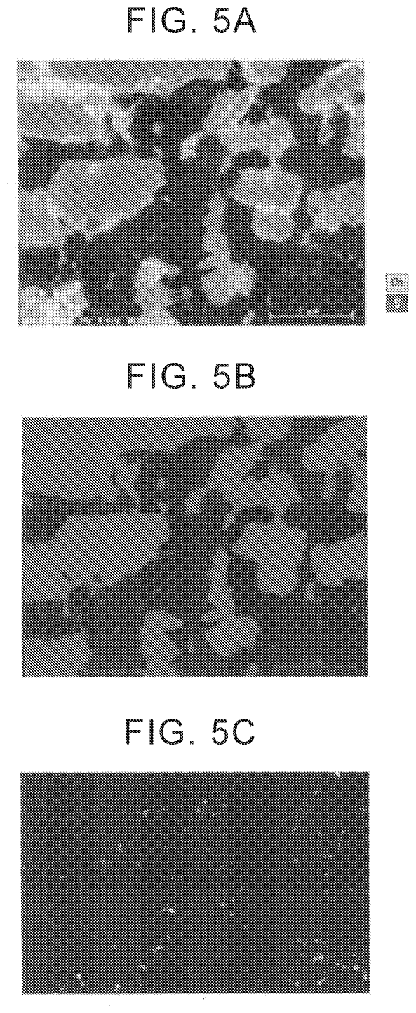

FIGS. 5A to 5C show images illustrating an image processing process for extracting the binder adsorbed on the lithium titanate in the negative electrode layer in the battery for evaluation obtained in the example. First, the mapping image of sulfur (S) and osmium (Os) acquired as described above (FIG. 5A) was separated by coloring both regions where Os elements exist and regions where S elements exist red and coloring the remaining regions black (FIG. 5B). Next, a large mass of area (regions composed of sulfide (S) elements of the sulfide solid electrolyte and osmium (Os) elements covering sulfide (S) of the sulfide solid electrolyte) was removed to extract the remaining Os elements, that is, the Os elements adsorbed on the lithium titanate (FIG. 5C). The number of pixels P4 for the extracted Os elements was counted to be 1,265 pixels.

The ratio of the amount A of the rubber binder adsorbed on the lithium titanate to the total content B of the rubber binder in the negative electrode layer was calculated by dividing the number of pixels P4 obtained as described above in (2) by the number of pixels P3 obtained as described above in (1) and expressing the quotient as a percentage ((P4/P3)×100 (%)). The calculated ratio (A/B) was 1.35%.

### Comparative Example

First, as in the example, Li₄Ti₅O₁₂ particles (LTO, density: 3.5 g/cc) as a negative electrode active material, an electrically conductive material (VGCFs, density: 2 g/cc), a binder (SBR, density: 0.9 g/cc), a dispersion medium (butyl butyrate), and a sulfide solid electrolyte (LiI—LiBr—Li₂S—P₂S₅ glass ceramic, density: 2 g/cc) were weighed.

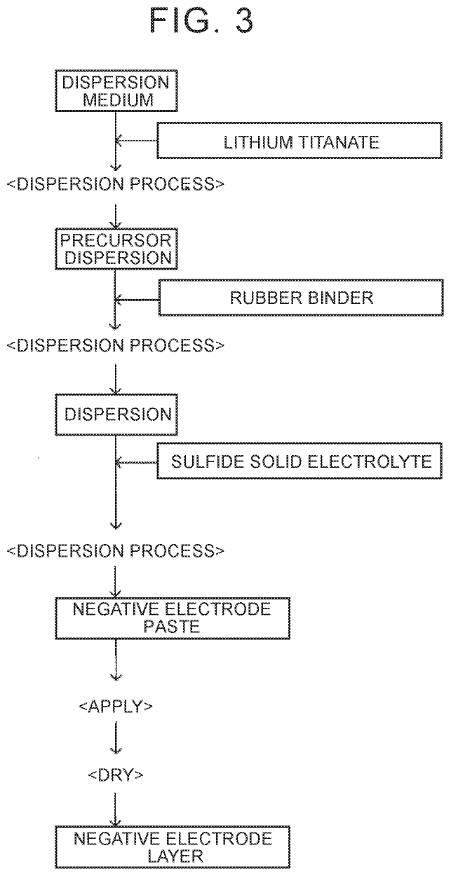

A negative electrode paste was obtained according to the flowchart shown in FIG. 3. First, the LTO particles were added to the dispersion medium and dispersed therein using an ultrasonic homogenizer (UH-50 made by SMT Co., Ltd.) to obtain a precursor dispersion. Next, the binder was added to the precursor dispersion and dispersed therein using the ultrasonic homogenizer (UH-50 made by SMT Co., Ltd.) to obtain a dispersion. The sulfide solid electrolyte was then added to the dispersion and dispersed therein using the ultrasonic homogenizer (UH-50 made by SMT) to obtain a negative electrode paste. An all-solid-state battery for evaluation was obtained in a manner similar to that of the example except that the negative electrode paste thus obtained was used.

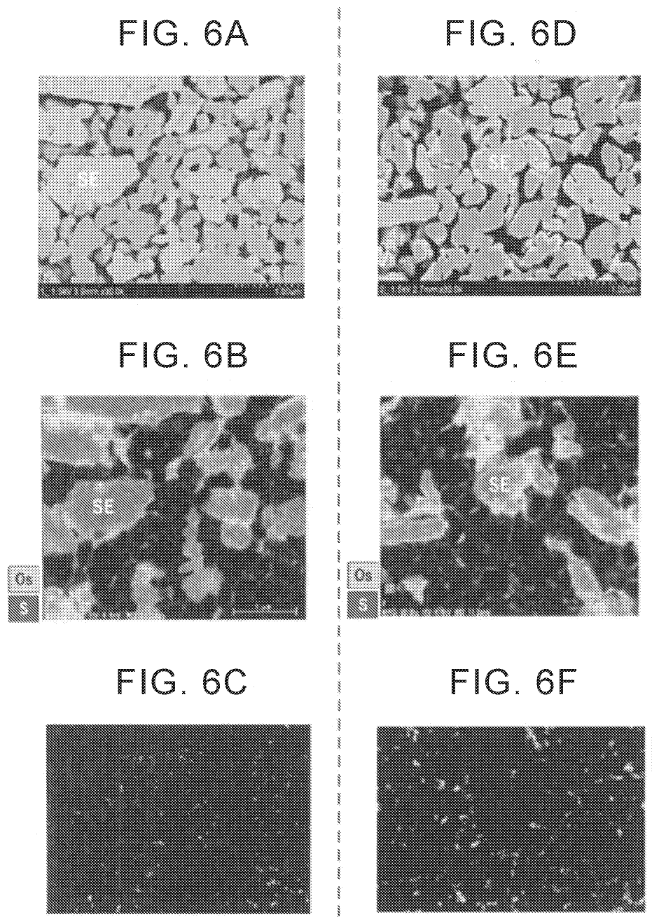

For the all-solid-state battery for evaluation manufactured in the comparative example, production of a test piece, acquisition of images, and image analysis were performed in a manner similar to that of the example. FIGS. 6A to 6F show SEM images, elemental mapping images, and extracted images of the binder adsorbed on the lithium titanate in a cross section of a negative electrode layer in the batteries for evaluation obtained in the example and the comparative example. In the comparative example, the number of pixels P1 in the extracted image of C elements was 690,624 pixels, and the number of pixels P2 in the extracted image of S elements was 241,380 pixels. The number of pixels P3 was calculated to be 449,244 pixels. The number of pixels P4 was 21,008 pixels. FIG. 6D shows an SEM image of the cross section of the negative electrode layer of the comparative example, FIG. 6E shows a mapping image of sulfur and osmium (S, Os image) in the cross section of the negative electrode layer of the comparative example, and FIG. 6F shows an Os image indicating Os adsorbed on LTO in the cross section of the negative electrode layer of the comparative example. Based on the above, the ratio of the amount A of the rubber binder adsorbed on the lithium titanate to the total content B of the rubber binder in the negative electrode layer was calculated to be 4.68%. For comparison, an SEM image, S, Os image, and Os image indicating Os adsorbed on LTO in the all-solid-state battery for evaluation of the example are shown in FIGS. 6A, 6B, and 6C.

Evaluation

Direct Current (DC) Resistance Measurement

The DC resistance of each of the all-solid-state batteries produced in the example and the comparative example was identified. Specifically, each of the all-solid-state batteries was charged at a constant current corresponding to 1 C. After the cell voltage reached 2.95 V, the all-solid state battery was charged at a constant voltage, and the constant voltage charging was ended when the charging current reached a value corresponding to 0.01 C. Thereafter, the all-solid-state battery was discharged at a constant current corresponding to 1 C, and the constant current discharging was ended when the voltage reached 1.5 V. Subsequently, the all-solid-state battery was charged with a constant current corresponding to 3 C. The DC resistance (charging resistance) was calculated by dividing the difference between the voltage before charging and the voltage after charging for 10 seconds by the current corresponding to 3 C. The results are shown in Table 1. The value of the charging resistance ratio in Table 1 is a relative value with respect to the comparative example.

TABLE 1

| | Ratio | |
|---|---|---|
| | A/B (%) | Charging Resistance Ratio |
| Example | 1.35 | 0.87 |
| Comparative Example | 4.68 | 1.00 |

As shown in Table 1, it was confirmed that the example had a lower charging resistance ratio than the comparative example. The reason why the example had a lower charging resistance ratio than the comparative example is presumed to be because a decrease in reaction area of the negative electrode active material was reduced due to the low ratio of the amount of the binder adsorbed on the negative electrode active material (lithium titanate) to the total content of the binder in the negative electrode layer.

What is claimed is:

1. A negative electrode layer that is used for an all-solid-state battery, the negative electrode layer comprising:
lithium titanate;
a sulfide solid electrolyte; and
a rubber binder, wherein
a ratio of an amount A of the rubber binder adsorbed on the lithium titanate to a total content B of the rubber binder in the negative electrode layer is 1.35% or less.

2. The negative electrode layer according to claim 1, wherein the rubber binder contains styrene-butadiene rubber.

3. The negative electrode layer according to claim 1, wherein the lithium titanate has a composition represented by Li₄Ti₅O₁₂.

4. The negative electrode layer according to claim 1, wherein
a proportion of the rubber binder in the negative electrode layer is 1% by volume or more and 20% by volume or less,
a proportion of the lithium titanate in the negative electrode layer is 20% by volume or more and 80% by volume or less, and
a proportion of the sulfide solid electrolyte in the negative electrode layer is 15% by volume or more and 75% by volume or less.

5. A method for manufacturing a negative electrode layer that is used for an all-solid-state battery, the method comprising:
preparing a dispersion in which a sulfide solid electrolyte and a first component are dispersed in a dispersion medium;
adding a second component to the dispersion and dispersing the second component in the dispersion to obtain a negative electrode paste; and
applying and drying the negative electrode paste to form the negative electrode layer, wherein one of the first component and the second component is lithium titanate, and the other is a rubber binder.

6. The method according to claim 5, wherein the first component is the lithium titanate, and the second component is the rubber binder.

7. The method according to claim 5, wherein preparing the dispersion includes
adding the first component to the dispersion medium and performing a first dispersion process to obtain a precursor dispersion, and
adding the sulfide solid electrolyte to the precursor dispersion and performing a second dispersion process to obtain the dispersion.

8. An all-solid-state battery, comprising:
a positive electrode layer;
a negative electrode layer; and
a solid electrolyte layer located between the positive electrode layer and the negative electrode layer, wherein
the negative electrode layer includes lithium titanate, a sulfide solid electrolyte, and a rubber binder, and
a ratio of an amount A of the rubber binder adsorbed on the lithium titanate to a total content B of the rubber binder in the negative electrode layer is 1.35% or less.

9. The all-solid-state battery according to claim 8, wherein the rubber binder contains styrene-butadiene rubber.
